(19) United States
(12) Patent Application Publication
(10) Pub. No.: US 2009/0104955 A1
(43) Pub. Date: Apr. 23, 2009

(54) GAME DEVICE

(75) Inventors: Sohei Yamamoto, Tokyo (JP); Taiji Sugai, Tokyo (JP); Masayoshi Ogata, Tokyo (JP); Takao Seki, Tokyo (JP)

Correspondence Address: SEED INTELLECTUAL PROPERTY LAW GROUP PLLC, 701 FIFTH AVE, SUITE 5400, SEATTLE, WA, 98104, US

(73) Assignee: KABUSHIKI KAISHI SEGA D/B/A SEGA CORPORATION, Tokyo (JP)

(21) Appl. No.: 12/185,628

(22) Filed: Aug. 4, 2008

(30) Foreign Application Priority Data
Aug. 6, 2007 (JP) 2007-204211

(51) Int. Cl. A63F 9/24; A63F 13/00

(52) U.S. Cl. 463/6

(57) ABSTRACT

A game device including: a first running surface; a second running surface positioned below the first running surface; a plurality of running objects which run on a track of the second running surface, each of the plurality of running objects including capturing unit for capturing an image; and a plurality of model objects which run on the first running surface following each of the plurality of running objects is provided. The game device further includes: a plurality of two-dimensional codes arranged in an information arrangement surface extending in parallel to the second running surface and capturable from the capturing units with sizes and a sequence in which one or more of the plurality of two-dimensional codes are always included in a field angle of the capturing unit of each of the plurality of running objects disposed in optional positions on the track of the second running surface; and a position detection unit for detecting positions of the plurality of running objects based on positional information recorded in the two-dimensional codes captured by the capturing unit. Thus, costs for position detection of the model objects in the game device in which the plurality of model objects run are reduced, accuracy of the position detection is enhanced, and time period required for the position detection is shortened.

### BACKGROUND

1. Technical Field

The present invention relates to a game device in which a plurality of model objects run on a predetermined running surface.

2. Description of the Related Art

Japanese Patent Application Laid-open No. Hei 10-216355 discloses a game device which enables a plurality of model objects to run with more vigor or reality. For example, this game device enables the plurality of model objects to run on a predetermined track while changing running courses with a certain degree of freedom so that the model objects race against one another to get close up (get congested) trying to get an advantageous inner course of a shortest running distance.

In the game device in which the plurality of model objects run while getting close up or racing against one another, in order, for example, to prevent falling of the model objects caused by contact between the model objects or to ensure that the model objects reach the goal in a predetermined order, running positions of the model objects have to be accurately grasped and controlled in real time.

In this regard, the game device of Japanese Patent Application Laid-open No. Hei 10-216355 is configured in such a manner that the model objects are pulled on the track by a plurality of running objects which run on a running surface disposed below the track, a coil matrix constituted of a number of lines extending in two directions (X and Y directions) orthogonal to each other and connected to a comparator circuit via switches is laid down below the running surface, and positions of the running objects are detected by an induction current generated in the coil matrix when an oscillation coil mounted on each running object is excited.

In the above-mentioned method, however, as the area of the running surface increases, it becomes necessary to enlarge the area of the coil matrix and to increase the number of switches. Therefore, a problem of excessive costs for position detection occurs when the game device is increased in size.

In addition, in the above-mentioned method, line intervals of the coil matrix place a limit on accuracy of position detection. Consequently, the number of lines has to be increased to improve the accuracy of position detection. However, there is a limit on the increase in number of lines in view of laying-down costs, and the increased number of lines leads to a longer period of time for detecting a position of each running object, causing a difficulty in carrying out position detection in real time.

Therefore, in the game device of Japanese Patent Application Laid-open No. Hei 10-216355, it is difficult to increase the size of the device or to realize a game device in which a plurality of model objects run at high speeds while vigorously racing against one another in a close-up state.

### BRIEF SUMMARY

The present invention has been made to solve the aforementioned problems, and aims to achieve one or more of the following objects.

In other words, an object of the present invention is to reduce costs for position detection, to improve accuracy of position detection and/or to shorten time period required for position detection of a plurality of model objects in a game device in which the objects run.

Another object of the present invention is to provide a game device in which a plurality of model objects run while closing up or racing against one another with vigor, in order, for example, for trying to get an advantageous course.

Still another object of the present invention is to enable an increase in number of model objects and/or an increase in running speeds of the model objects in a game device in which a plurality of model objects run while closing up or racing against one another.

In order to solve the above-mentioned problems, the present invention relates to a game device (Claim 1), in which a game progresses as a plurality of model objects run, comprising:

a first running surface;

a second running surface positioned below the first running surface;

a plurality of running objects which run on a track of the second running surface, each of the plurality of running objects including capturing means for capturing an image; and

the plurality of model objects which run on the first running surface following any of the running objects

a plurality of two-dimensional codes recording positional information in the second running surface, the plurality of two-dimensional codes being arranged in an information arrangement surface extending in parallel to the second running surface and capturable from the capturing means; and

a position detection means for detecting positions of the plurality of running objects based on the positional information recorded in the plurality of two-dimensional codes captured by the capturing means; wherein:

the plurality of two-dimensional codes are arranged with sizes and a sequence in which, irrespective of the position of any of the plurality of running objects on the track of the second running surface, at least one or more of the plurality of two-dimensional codes are included in a field angle of the capturing means thereof.

In the information arrangement surface of the present invention, the two-dimensional codes are arranged with the size and the sequence in which at least one or more two-dimensional codes are included in the field angle of the capturing means of each running object. Accordingly, positional information can be obtained from the two-dimensional codes included in an image captured at an optional timing. As a result, a position of the running object can be detected in a shorter time cycle or continuously, and control accuracy of running of the running object can be heightened.

When the game device of the present invention is increased in size to increase a track length or a track area, the size of the information arrangement surface has accordingly to be increased. However, the two-dimensional codes can be formed by an inexpensive method such as printing, and the accuracy or the required time period of position detection by capturing the image of the two-dimensional codes is not affected by the size of the information arrangement surface. Thus, according to the present invention, the game device can be easily increased in size without greatly increasing costs or without reducing the accuracy of position detection or extending the time period necessary for position detection.

In the game device of the present invention, a game progresses as a plurality of model object run on the first running surface. Thus, the game device can be configured so that the information arrangement surface cannot be viewed from the outside (from a player positioned in a playing position, such as a satellite). In this case, there is no need to take the influence of arranging the two-dimensional codes on a design or an appearance of the game device into consideration. Thus, two-dimensional codes can be formed by using inexpensive visible ink. As a result, costs of forming the two-dimensional codes can be reduced, maintenance such as inspection or repairing of the two-dimensional codes can be facilitated, and/or costs of the capturing means can be reduced compared with the case of using capturing means for infrared-rays.

The position detection means of the present invention preferably detects the position of the running object, based on a position and an angle of the two-dimensional code in the image captured by the capturing means and the positional information recorded in the two-dimensional code (Claim 2).

In other words, when a position of the running object is detected only based on the positional information recorded in the two-dimensional codes, an arrangement density of the two-dimensional codes places a limit on the accuracy of position detection. In this regard, it is possible, in the invention in claim 1, to heighten arrangement density of the two-dimensional codes without greatly increasing costs or without increasing required time period or processing loads of the position detection, because of easy arrangement of the two-dimensional codes. However, there is a limit in heightening the density of the two-dimensional codes in view of a resolution necessary for decoding to obtain the positional information, and thus it is impossible to further heighten the accuracy of the position detection of the running object.

In this regard, according to the invention of Claim 2, as long as the image captured by the capturing means includes one or more QR codes, position detection can be carried out with extremely high accuracy irrespective of the arrangement density of the two-dimensional codes.

The position detection means of the present invention can further derive an angle (advancing direction) of the running object from an angle of a QR code in the image captured by the capturing means. Thus, running controllability of the running object can be more enhanced.

Each of the plurality of running objects of the present invention preferably includes: the position detection means; and driving control means for controlling running of the running object based on the position of the running object detected by the position detection means (Claim 3).

According to the present invention, the running object can carry out autonomous running control based on own positional information detected by itself. Therefore, as compared with the case of controlling running of the running object based on control from a controller located away from the running object, processing time or processing loads for transmission/reception of positional information or a control signal can be reduced.

The running object of the present invention preferably includes lighting means for lighting the field angle of the capturing means (Claim 4). This arrangement enables capturing of the two-dimensional codes by the capturing means under more stable conditions. In the present invention, a configuration to prevent an entry of an external light into the information arrangement surface enables further stabilization of capturing conditions of the two-dimensional codes by the capturing means.

In the present invention: the plurality of two-dimensional codes are preferably arranged in the information arrangement surface with sizes and a sequence in which, irrespective of the positions of any of the plurality of running objects on the track of the second running surface, at least two of the plurality of two-dimensional codes are included in the field angle of the capturing means thereof; and the position detection means preferably executes, when position detection of any of the running objects based on one of the two-dimensional codes in the image captured by the capturing means fails, position detection of the running object based on another of the two-dimensional codes in the captured image (Claim 5).

According to the present invention, even if position detection based on one of the two-dimensional codes included in the image captured by the capturing means fails due to, for example, stains or foreign objects on the information arrangement surface or fluctuations in capturing conditions, position detection can be executed based on the another of the two-dimensional codes. Thus, position detection of the running object can be carried out more surely.

In the present invention, “model object” means an object running on the first running surface and having optional (arbitrary) shape, and “running object” means an arbitrary object running on the second running surface.

In the present invention, “run” or “running” means to move a position on the first or second running surface as time passes, and the phrase, “a model object runs following a running object”, means that the model object runs with keeping a predetermined positional relation to the running object.

In the present invention, “two-dimensional code” means a graphic code which records information containing at least positional information on the second running surface by a two-dimensional graphic pattern.

In the present invention, the phrase, “two-dimensional code is included in a field angle” means that at least an area of the two-dimensional code, which enables reading of positional information recorded in the two-dimensional code, is included in the field angle.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

In the accompanying drawings:

FIG. 1 is a perspective explanatory view of an appearance configuration of a horse-race game device according to a first embodiment of the present invention;

FIGS. 2A and 2B are perspective view and a plan explanatory view of a configuration of a device main body;

FIG. 3A is an explanatory view of a bottom plate 7 housed in the device main body in plan view;

FIG. 3B is an explanatory diagram of a sequence of two-dimensional codes C in a surface of the bottom plate;

FIG. 4 is an explanatory diagram of a configuration of a model object and a running object;

FIG. 5 is an explanatory view of a configuration of a satellite;

FIG. 6 is an explanatory diagram of a satellite screen;

FIG. 7 is an explanatory diagram of a schematic configuration of a hardware of the horse-race game device;

FIG. 8A is an explanatory diagram of an exemplary form of a QR code;

FIG. 8B is an explanatory diagram of an exemplary image of an information arrangement surface captured by a camera device; and

FIGS. 9A and 9B are flowcharts each illustrating a flow of a position detection process executed according to the first embodiment of the present invention.

### DETAILED DESCRIPTION OF THE PREFERRED EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with game devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The preferred embodiments of the present invention will be described below with reference to the accompanying drawings.

The present invention is applied to a game device in which a game progresses as a plurality of model objects having arbitrary shapes run on a running surface. In the embodiments described below, a description is made of a case in which the present invention is applied to a horse-race game device in which model objects imitating horses and jockeys race against one another to arrive earlier.

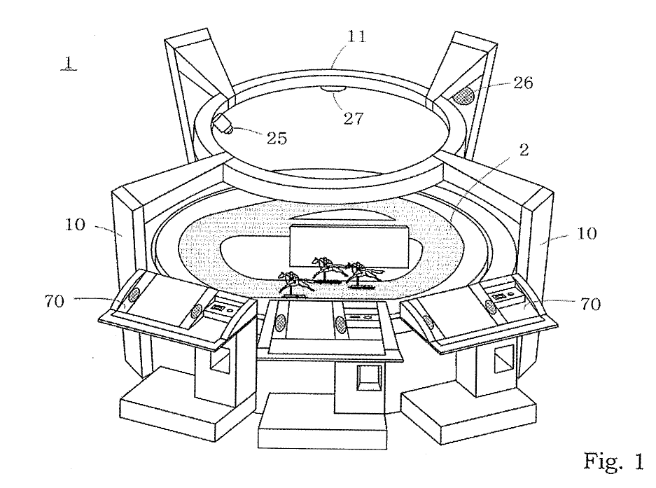

FIG. 1 is a perspective explanatory view illustrating an appearance configuration of a horse-race game device 1 according to a first embodiment of the present invention.

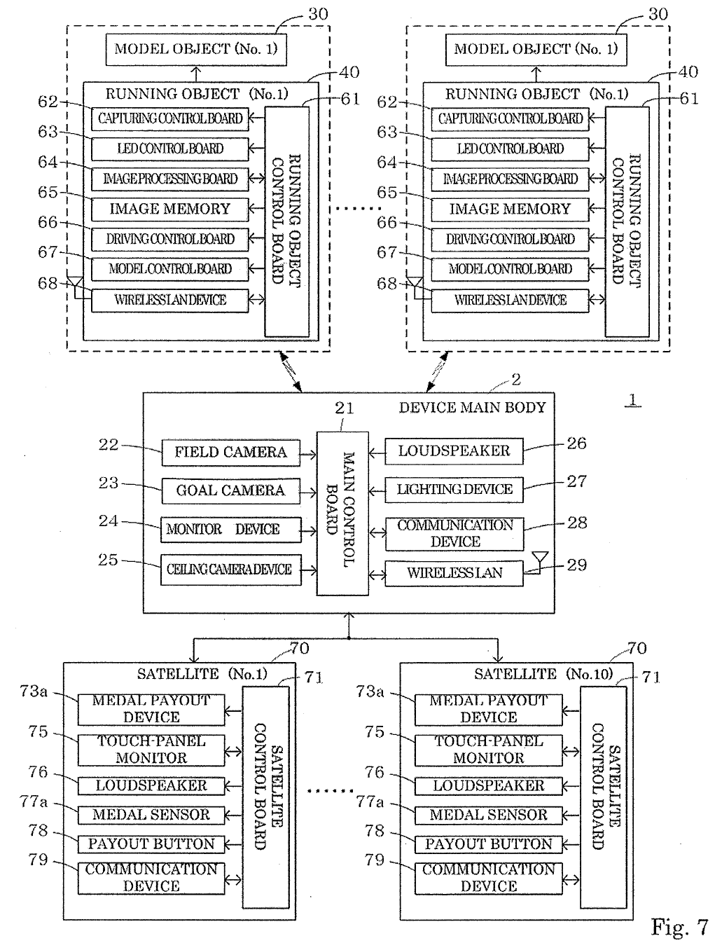

As illustrated in FIG. 1, this horse-race game device 1 mainly includes a roughly cylindrical device main body 2 placed in the middle of a casing and housing a main control board 21 and others (refer to FIG. 7) described below, and a plurality of satellites (game terminals) 70 arranged around the device main body 2 and electrically connected to the main control board 21 via a communication cable or the like.

FIG. 1 illustrates only three front satellites 70 for brevity, however, in the horse-race game device 1 of this embodiment, for example, twelve satellites 70 are arranged around the device main body 2.

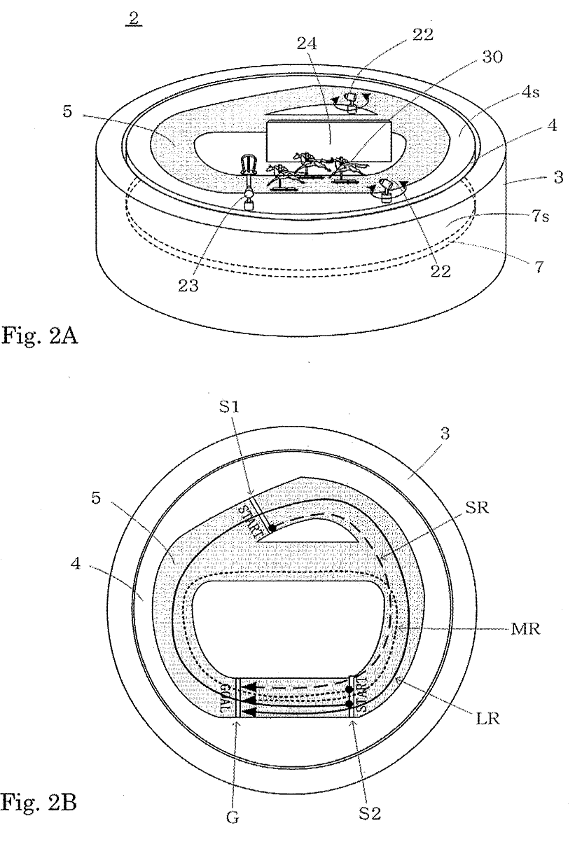

FIGS. 2A and 2B are a perspective view and a plan explanatory view of a configuration of the device main body 2, respectively.

As illustrated in FIGS. 2A and 2B, the device main body 2 includes an outer cylindrical casing 3, and a two-story structure constituted of a top plate 4 and a bottom plate 7 arranged away from each other in the vertical direction.

The top plate 4 is a plate member having a roughly circular shape and the upper surface thereof is a first running surface 4s visible to a player located at the satellite 70. In the first running surface 4s, a track 5 on which a plurality of model objects 30 race against one another to arrive earlier is formed, and further, a plurality of field cameras 22 and a goal camera 23 for capturing the model objects 30 running on the track 5, a monitor device 24 for displaying images captured by the cameras 22 and 23 or race information, and the like are arranged. According to this embodiment, to realistically reproduce an appearance of a racecourse, the track 5 and its surroundings are covered with artificial lawns prepared by processing green powders, fibers, or the like.

As illustrated in FIG. 2B, the track 5 is formed into an “8”-shape. Accordingly, in the horse-race game device 1 of this embodiment, by selecting one among a plurality of running courses indicated by symbols SR, MR, and LR extending from start points S1 and S2 to a goal G according to a race type, races can be carried out on a plurality of types of running courses including short, middle, and long distances.

Though not shown in FIGS. 2A and 2B, in this embodiment, to change the number of model objects 30 which run on the track 5 in each race, the device main body 2 can include housing means for housing the model objects 30 in a proper place such as the outer peripheral portion of the top plate 4.

The device main body 2 can further include, to reproduce a start scene similar to a real horse race, a starting gate disposed at the start point S1 or S2 at the time of starting each race, and retracted and housed in a proper place of the outer peripheral portion or the like of the top plate 4 during the race. In this case, the starting gate can be configured similar to the starting gate disclosed in Japanese Patent Application Laid-open No. Hei 10-216355.

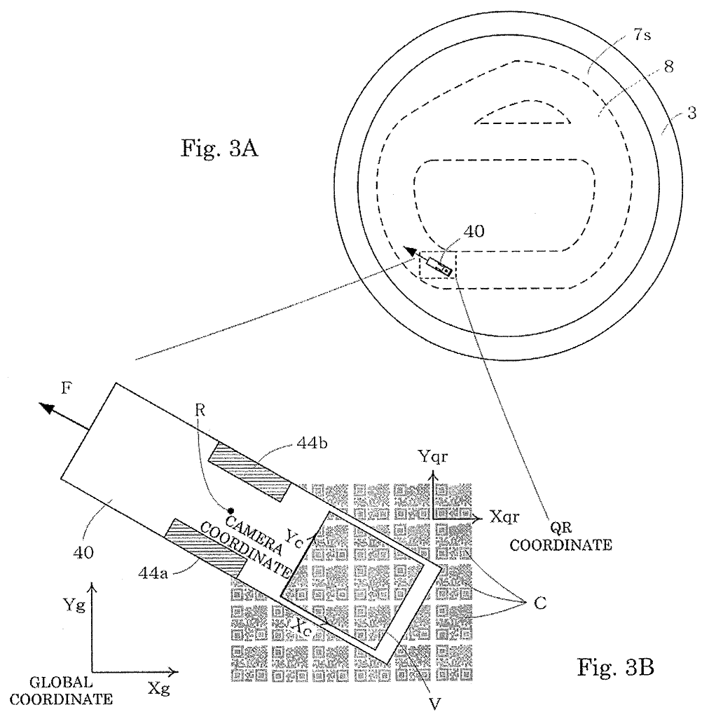

FIG. 3A is an explanatory view of the bottom plate 7 in plan view, which is disposed in a position downward away by a predetermined distance from the top plate 4. FIG. 3B is an explanatory view showing a manner of arranging two-dimensional codes (i.e., machine-readable symbols) C in the surface of the bottom plate 7.

As illustrated in FIG. 3A, the bottom plate 7 is a plate member which has a circular shape similar to that of the top plate 4. An area of its upper surface, which corresponds to the track 5 of a second running surface 7s, is a track 8 on which a plurality of running objects 40 run in a race.

The surface of the entire second running surface 7s or at least the track 8 is an information arrangement surface in which a number of two-dimensional codes C recording (e.g., encoding) positions on global coordinates which are orthogonal coordinates fixed to the second running surface 7s are arranged. Note that, in this embodiment, QR codes (JIS-X-0510) are used as two-dimensional codes C.

As illustrated in FIG. 3B, the QR codes C are arrayed in matrix at fixed intervals in Xg and Yg axes directions of the global coordinates. In addition, each QR code C is arranged at an angle in which Xqr and Yqr axes directions of QR coordinates, which are orthogonal coordinates on the QR code C, align the Xg and Yg axes directions of the global coordinates.

The QR codes C are arranged, considering a capturing angle of a camera device 46 mounted on the running object 40 and a distance from the camera device 46 to the second running surface 7s, with sizes and intervals so that, in whichever position of the track 8 the running object 40 is, one or more of the QR codes C are always included in a field angle (field of view) V of the camera device 46. A running object control board 61 described below derives a position and an angle (advancing direction) F of a reference point (e.g., axle center position of center wheels 44a and 44b) R of the running object 40 on the global coordinates, based on positional information recorded in the QR code C in the image captured by the camera device 46 and a position and angle of the QR code C on camera coordinates (Xc and Yc) fixed to the image captured by the camera device 46. Note that, in order to enable acquisition of positional information from the other QR code C in case of failing to acquire positional information from one QR code C in the captured image, the QR codes C are preferably arranged with sizes and intervals so that entireties of two or more QR codes C are always included in the field angle V of the camera device 46.

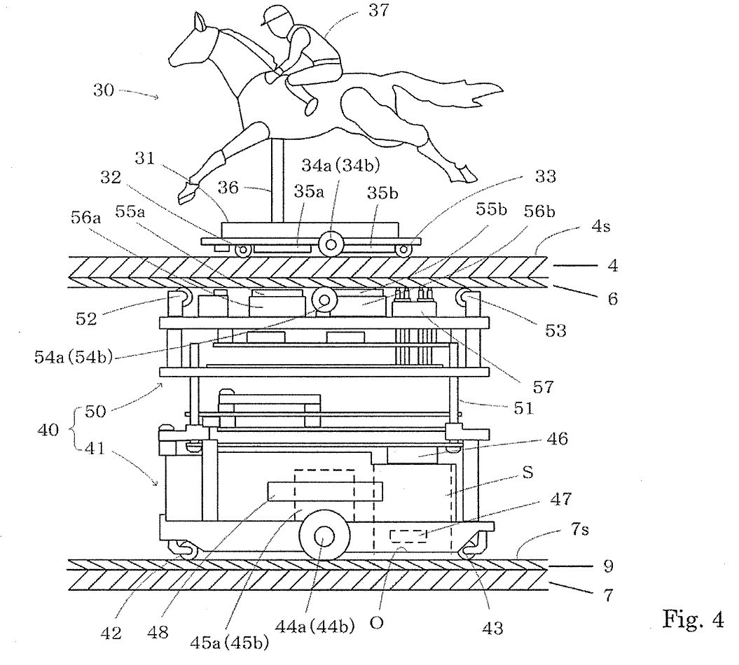

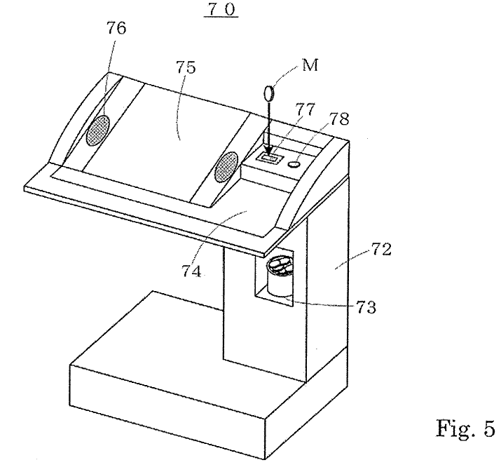

The QR codes C are preferably arranged by printing the QR codes C on one surface of a transparent thin plate 9 (refer to FIG. 4) such as polycarbonate, and laying down the transparent thin plate 9 with the printed surface down on the bottom plate 7. Accordingly, for example, damage of the QR codes C caused by running of the running object 40 can be prevented.

This embodiment employs a structure in which the information arrangement surface having QR codes C arranged therein is covered with the outer casing 3 and the top plate 4 to be invisible to a player seated in a satellite 70. Therefore, no influence on a design or an appearance of the device is caused by providing QR codes C using visible ink. Thus, by providing visible QR codes C with using visible ink or the like, it is possible to reduce costs for printing, facilitate maintenance such as inspection or repairing of the QR codes C, and/or enable use of the camera device 46 more inexpensive compared with the case in which a camera device for infrared rays is used.

Further, the outer casing 3 and the top plate 4 are made of light-shielding members, which prevents an influence of lighting in a game hall in which the horse-race game device 1 is installed on capturing of the camera device 46. Thus, reading stability of positional information recorded in the QR codes C can be enhanced.

FIG. 4 is an explanatory view of the model object 30 and the running object 40 in side view, which are arranged in the first and second running surfaces 4s and 7s.

As illustrated in FIG. 4, the model object 30 includes a carriage 31 and a model portion 37 fixed on the carriage 31 via a support pillar 36.

The carriage 31 is enabled to run on the first running surface 4s by front and rear wheels 32 and 33, and center wheels 34a and 34b rotatably supported on both sides of the truck 31. Two rotary magnets 35a and 35b are fixed to a bottom surface of the carriage 31 with slight intervals from the first running surface 4s.

The rotary magnets 35a and 35b are magnetically coupled with rotary magnets 55a and 55b of the running object 40 described below to enable to run the model object 30 on the first running surface 4s following a corresponding running object 40 (with keeping a predetermined positional relation with the corresponding running object 40) which runs on the second running surface 7s.

The rotary magnets 35a and 35b are rotatable around vertical axes, and rotated in synchronization with rotations of the rotary magnets 55a and 55b by model control motors 56a and 56b. The rotations of the rotary magnets 35a and 35b are transmitted to the model portion 37 via the support pillar 36 and a gear mechanism (not shown).

The model portion 37 is an imitation of a horse (racehorse) and a jockey. Horse's legs and jockey's limbs can rock around joint axes thereof. The jockey's limbs rock when the rotation of the rotary magnet 35a is transmitted via the support pillar 36, and horse's fore-legs and rear-legs rock when the rotation of the rotary magnet 35b is transmitted via the support pillar 36.

The running object 40 includes a carriage 41 and a support base 50.

Front and rear wheels 42 and 43, left and right center wheels 44a and 44b, and running motors 45a and 45b which drive the center wheels 44a and 44b, respectively are mounted on the carriage 41. The running motors 45a and 45b controlled by a driving control board 66 independently drive the left and right center wheels, thereby enabling the running object 40 to run on its own (self-run) on the second running surface 7s with freely changing its advancing direction.

The carriage 41 further includes mechanical components including a camera device 46 such as a CCD camera fixed in an upper portion of a cavity S having a bottom opening O to vertically capture the second running surface 7s, a white LED 47 fixed to both sides of the camera device 46 to light a field angle V of the camera device 46, and an antenna 48 to communicate with the device main body 2 via a wireless LAN.

The support base 50 is fixed above the carriage 41 with receiving upward urging forces from springs 51.

Front and rear wheels 52 and 53 and left and right center wheels 54a and 54b are fixed to an upper surface of the support base 50. Those wheels 52 to 54 receive urging forces from the springs 51 to abut on a bottom surface of the top plate 4. Accordingly, the running object 40 is held between the lower wheels 42 to 44 and the upper wheels 52 to 54, and can stably run in a running space between the top plate 4 and the bottom plate 7 with keeping an upright posture.

The support base 50 further includes rotary magnets 55a and 55b, model control motors 56a and 56b, and a current collector 57.

The rotary magnets 55a and 55b are fixed with an arrangement corresponding to the rotary magnets 35a and 35b of the model object 30 with slight intervals from the top plate 4, and driven by the model control motors 56a and 56b to rotate around vertical axes. The rotary magnets 55a and 55b are magnetically coupled with the rotary magnets 35a and 35b, and pull the model object 30 on the top plate 4 as the running object 40 runs. At the same time, rotations of the rotary magnets 55a and 55b cause rocking of the horse's legs and the jockey's limbs in the model portion 37 of the model object 30.

The current collector 57 receives, during running of the running object 40, proper pressing forces from the springs 51 to slidably contact with a feeder plate 6 fixed to the bottom surface of the top plate 4, and supplies power necessary for controlling running of the running object 40.

The feeder plate 6 can be configured by, for example, alternately arrayed positive and negative electrodes of stripe patterns apart from each other by a predetermined distance. The current collector 57 includes eight pin-contacts arranged in apex positions of a regular octagon. Two or more pin-contacts always keep contact with both positive and negative electrodes so that power can be stably supplied to the running object 40.

FIG. 5 is a perspective explanatory view of a configuration of each satellite 70.

The satellites 70 are identical to one another in configuration. As illustrated in FIG. 5, each satellite 70 is installed on a floor of a game hall of an amusement arcade or the like, and mainly includes a leg 72 erected upward from a base member in which feet or baggage of a player seated on a seat (not shown) is placed, and a table 74 supported by an upper end side of the leg 72.

The leg 72 includes a medal payout port 73. The table 74 includes a touch-panel monitor 75 to display an image, such as a satellite screen SP, and detect player's touching operation, a loudspeaker 76 to output sounds for various representations such as a live broadcast, a fanfare, and BGM, a medal insertion port 77 in which medals are inserted, and a payout button 78 to pay out obtained medals. Each satellite 70 incorporates mechanical components such as a medal payout device 73a to pay out medals to the medal payout port 73, and a medal sensor 77a to detect medals inserted through the medal insertion port 77 and to count the number of inserted medals.

In each satellite 70, when a vote wins a prize to generate a right to receive returns, the number of obtained medals is stored and managed as a numerical value of credit medals, and a bet can be placed by using the credit medals. When medals are wanted to be paid out, by pressing the payout button 78, the number of medals corresponding to the numerical value of credit medals can be paid out from the medal payout port 73.

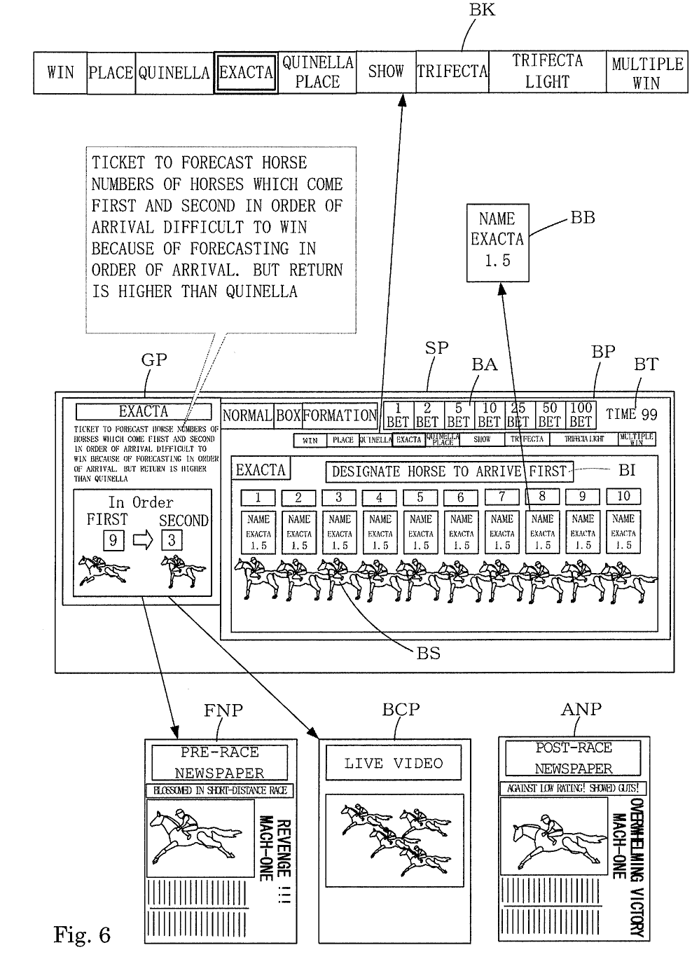

FIG. 6 is an explanatory view of an exemplary aspect of a satellite screen SP displayed on the touch-panel monitor 75.

As illustrated in FIG. 6, in the satellite screen SP of this embodiment, on the right side of the display screen, a voting screen BP is always displayed for a vote on the orders of arrivals of the model objects 30 in each race. On the left side of the display screen, an instruction screen GP, a pre-race newspaper screen FNP, a live screen BCP, a post-race newspaper screen ANP, and the like are displayed at respective predetermined timings.

On the voting screen BP of this embodiment, amount buttons BA to designate the number of medals to be betted for each operation, designation manner buttons BK to select a preferred designation manner from nine types of designation manners including “WIN”, “PLACE”, “QUINELLA (STRAIGHT FORECAST)”, “EXACTA (DUAL FORECAST)”, “QUINELLA PLACE”, “SHOW”, “TRIFECTA”, “TRIFECTA LIGHT”, and “MULTIPLE WIN”, an instruction column BI to instruct designation methods of the orders of arrivals, bet buttons BB displaying a horse number, a horse name, and odds of a racehorse allocated to each model object 30 by the main control board 21, and images BS of model objects 30 (image of a racehorse and a jockey allocated to the model object 30) corresponding to each bet button BB are displayed. By operating the bet button BB in a state of selecting one of the amount buttons BA and one of the designation manner buttons BK, a vote in which an order of arrivals is designated in the selected designation manner can be placed with the selected number of medals as a fee.

Here, “WIN” is to designate the number of a racehorse allocated to the model object 30 which arrives a goal G first (hereinafter, simply referred to as a “racehorse arrives first”). “PLACE” is to designate the number of a racehorse arrives first or second. “QUINELLA” is to designate a set of numbers of racehorses arrive first and second. “EXACTA” is to designate numbers of racehorses arrive first and second in order of arrivals. “QUINELLA PLACE” is to designate two arbitrary numbers of racehorses arrive first to third. “SHOW” is to designate a combination of numbers of racehorses arrive first to third. “TRIFECTA” and “TRIFECTA LIGHT” is to designate numbers of racehorses arrive first to third in order of arrivals. “MULTIPLE WIN” is to designate order of arrivals of racehorses over a plurality of races.

As described above, “TRIFECTA” and “TRIFECTA LIGHT” are the same in the manner of designating the order of arrivals. However, in these designation manners, a probability that the vote will win a prize is low (e.g., average of 1/720 in the case of ten horses). Thus, many players prefer a box vote which designates order of arrivals of all combinations so that, for example, three to eight racehorses are designated and prizes can be won no matter which three of the three to eight racehorses arrive first to third. However, in the case of an 8-horse box, a vote designating 336 kinds of orders of arrivals is required, necessitating 336 medals, even assuming one medal fee for each order. Thus, a box-voting requiring many medals cannot be placed casually. “TRIFECTA LIGHT” has been conceived considering this situation to accept a vote in the designation manner of “TRIFECTA” with minimum fee of 0.1 medal. Accordingly, for the vote in the 8-horse box of “TRIFECTA LIGHT” with 0.1 medal as a fee for each of the orders, 33.6 medals are required. In such case, for convenience of medal processing, the vote is accepted with 34 medals by rounding up the fractional portion thereof.

In the voting screen BP shown in FIG. 6, a state in which the designation manner of “EXACTA” is selected from the designation manner buttons BK is shown. Taking this case as an example, a voting method will be described below.

In an initial state in which the designation manner of “EXACTA” is selected from the designation manner buttons BK, “DESIGNATE HORSE WHICH ARRIVES FIRST” is displayed in the instruction column BI. When a bet button BB of a horse number expected to arrive first is pressed after any of the preferred amount button BA is pressed, the instruction column BI changes to display “DESIGNATE HORSE WHICH ARRIVES SECOND”. Accordingly, the player presses the bet button BB of the horse number expected to arrive second. Thus, a vote designating an order of arrivals selected by pressing the bet button BB, in the designation manner selected by the designation manner button BK, with the number of medals designated by the amount button BA as a fee, is accepted.

In any of the other designation manners, following the instructions in the instruction column BI, a vote can be placed in a similar manner.

Votes can be repeatedly placed as many time as a player like, until a remaining time display BT becomes zero. Therefore, for one race, a plurality of votes can be placed in a plurality of designation manners with an optional number of medals as a fee and designating a plurality of orders of arrivals.

In this embodiment, to arouse player's interest in voting, a predetermined performance by a racehorse in an image BS is made for each pressing of the bet button BB.

Specifically, when the bet button BB is pressed to place a bet, a scene in which a racehorse in the corresponding image BS starts to walk is displayed. When a bet is placed more, the racehorse gradually runs. When betting reaches a maximum, a jockey riding the racehorse thrusts his fist, and an image brightly showing the racehorse and the jockey is displayed.

Further, in this embodiment, in association with the movements of the horse and the jockey in the image BS as described above, horse's legs and jockey's limbs rock in the model portion 37 of the corresponding model object 30 disposed at the start point S1 or S2. Because unprecedented visual reaction as above is generated for the betting behaviors, player's interest in voting can be visually aroused.

The instruction screen GP is for displaying instructions of each designation manner according to selection of the designation manner button BK. Through the instruction screen GP, the player can understand a method for designating an arrival order in each designation manner and return characteristics.

The pre-race newspaper screen FNP is displayed at a timing before a start of each race. In other words, through this pre-race newspaper screen FNP, information useful for arrival order forecasting, for example, on which of a plurality of racehorses taking part is strong is provided to the player before a start of each race, thereby assisting player's forecasting of order of arrivals.

The post-race newspaper screen ANP is displayed at a timing after an end of each race. In other words, through this post-race newspaper screen ANP, result information, for example, on how a racehorse has won a victory is provided to the player after an end of each race.

From pieces of information displayed in the pre-race newspaper FNP and the post-race newspaper ANP, the player can learn a horse name, race records and features of each racehorse, and even a beginner can gradually acquire an ability to accurately forecast the orders of arrivals by experiencing several races.

Note that, in the pre-race newspaper FNP and the post-race newspaper ANP, phrases or sentences suited to respective races are automatically generated, or images suited to respective races are automatically selected so that news contents different from one race to another can be displayed.

The live screen BCP is displayed during execution of each race, and designed to display a composite image obtained by combining images captured by the field camera 22 and the goal camera 23 with an image prepared beforehand. In this live screen BCP, for example, by displaying a composite image such as a coin mark, which of the model objects 30 the player has betted or which of the model objects 30 is the most popular can be visually indicated to a player. By displaying information on a distance to a goal, or cheering comments for a racehorse betted by a player, it is also possible to further arouse player's interest.

Referring back to FIG. 1, four support pillar members 10 are erected on the sides of the device main body 2, and a ring-shaped ceiling member 11 is fixed to the upper ends thereof. In the support pillar members 10 and the ceiling member 11, a ceiling camera 25 to capture a bird's eye view picture of the track 5 from above, a loudspeaker 26 to output sounds for various representations such as a live broadcast, a fanfare, and BGM, and a lighting device 27 to emit lights for various representations are disposed.

Note that, in this embodiment, the track 5 formed in the top plate 4 is disposed below the table 74 so that the track 5 can be looked down from a player seated in the satellite 70. Therefore, a player seated in each satellite 70 can watch races with the same feelings as those of looking down a track from a gondola seat in a real horse race course.

FIG. 7 is an explanatory view of a schematic configuration of a hardware of the horse-race game device 1.

As illustrated in FIG. 7, in the horse-race game device 1 of this embodiment, the device main body 2 includes a main control board 21, each running object 40 includes a running object control board 61, and each satellite 70 includes a satellite control board 71. The main control board 21 can transmit/receive data to/from the running object control board 61 and the satellite control board 71 via a wiring cable or a wireless LAN line. Each of the main control board 21, the running object control board 61 and the satellite control board 71 is an information processing device which includes a CPU, and a recording device such as a ROM, a RAM, a hard disk and the like.

To the main control board 21, the field camera 22, the goal camera 23, the monitor device 24, the ceiling camera 25, the loudspeaker 26, the lighting device 27, the communication device 28, and the wireless LAN device 29 are connected. The main control board 21 drives and controls those devices according to a progress of a race, generates running data or decides odds for the running objects 40 based on horse data recorded in the recording device, and decides the order of arrival based on positional data of the running objects 40 sent from the running control boards 61, thereby controlling a progress of a horse-race game.

The horse data includes data such as horse names and running performance values which are parameters representing strengths of a plurality of racehorses in races. The same names as those of real racehorses may be used. In this embodiment, however, to enable players not so knowledgeable about real horse races to enjoy races, an original (fictional) name is used for each racehorse. Regarding the running performance values, a fixed value may be used for each of the racehorses for every races. However, a running performance value may be increased/decreased according to a length of a running course or compatibility with weathers or course conditions set for each race to provide greater diversity of race developments for each race. To enable a player who often plays with the horse-race game device 1 to make more appropriate forecast, it is also possible to increase/decrease running performance values depending on past records.

As the horse data, data for the same number of racehorses as the model objects 30 (e.g., 6 to 12 objects) to be arranged on the track 5 may be recorded. However, by recording data on more racehorses (e.g., 100 horses), it becomes possible to increase race diversity by running racehorses different from one race to another (by allocating them to the model objects 30).

The main control board 21 allocates any one of the racehorses recorded in horse data to each model object 30 arranged on the track 5, and generates running data according to an appropriate algorithm using running performance values of the allocated racehorses or a random number for diversifying race developments. These running data can be those designating positions of each running object 40 on the track 8 with respect to a passage of time from a race start to a goal.

Odds are return ratios (return magnifications) set so that an expected value of the number of medals paid out for a vote depositing one medal as a fee is equal to a payout rate PO (return rate: a value obtained by dividing the total number of medals paid out as returns by the total number of medals deposited as fees for in all votes). The main control board 21 calculates odds D for all orders of arrivals in each designation manner based on the running performance values of racehorses allocated to the model objects 30.

For the odds D in the embodiment, for example, odds D1 of a racehorse NO. 1 in “WIN” are derived from the following equation (1), and odds D12 of racehorses NOS. 1 and 2 in “QUINELLA” are derived from the following equation (2), in which the number of racehorses taking part in a race is n (numbered 1 to n), A1 to An indicate running performance values of the racehorses, and AS indicates a total of all the running performance values A1 to An.

D1=AS×PO/A1 (1)

D12={1/(A1/AS)×(A2/(AS−A1))+(A2/AS)×(A1/(AS−A2))} (2)

The order of arrivals of the model objects 30 is decided by comparing the time of arrival to the goal of each model objects 30 to each other based on the positions of each running object 40 on the second running surface 7s at each time, which is transmitted from the running object 40. The order of arrivals is decided not based on the running data but based on the position data of real running objects 40 for the purpose of preventing occurrence of troubles when the model objects 30 reach the goal in an order different from that according to the running data for one reason or another.

To the satellite control board 71, the medal payout device 73a, the touch-panel monitor 75, the loudspeaker 76, the medal sensor 77a, the payout button 78, and the communication device 79 are connected. The satellite control board 71 executes processes including image displaying on the touch-panel monitor 75, detection of player's touch entry on the touch-panel monitor 75, voice outputting of the loudspeaker 76, counting of medals at the medal sensor 77a inserted through the medal insertion port 77, and control of the medal payout device 73a for return paying-out or medal paying-out based on an operation of the payout button 78.

More specifically, the satellite control board 71 displays, based on data sent from the main control board 21, a name or odds of a racehorse allocated to each model object 30 by the main control board 21 for each race on the touch-panel monitor 75, detects player's operation for the voting screen BP to accept a vote, determines presence of a win based on whether arrival order data sent from the main control board 21 matches the order of arrivals designated in the vote after an end of each race, and pays out, if a win is present, the number of medals calculated by multiplying the number of medals deposited as fee in the winning vote by odds D as returns from the medal payout port 73, or increases a credit medal count value.

To each of the running control board 61, a capturing control board 62, a LED control board 63, an image processing board (FPGA) 64, an image memory 65, a driving control board 66, a model control board 67, and a wireless LAN device 68 are connected.

The capturing control board 62 is for controlling a capturing operation of the camera device 46. According to this embodiment, under the control of the capturing control board 62, the camera device 46 captures QR codes C on the second running surface 7s which is an information arrangement surface at high speed of about 2 to 200 times per second.

The LED control board 63 lights and controls the white LED 47 to emit an illumination light necessary for capturing by the camera device 46 to the information arrangement surface.

The image processing board 64 scans each image captured by the camera device 46 to extract markers set on three apexes of each QR code C included in each image, and decodes QR codes C in the captured image extracted by the running control board 61.

The image memory 65 is for temporarily storing images captured by the camera device 46.

The driving control board 66 and the model control board 67 respectively drive and control the running motors 45a and 45b and the model control motors 56a and 56b according to signals from the running object control board 61.

The running object control board 61 extracts a QR code C from markers extracted by the image processing board 64, specifies the position and the angle F of the reference point R of the running object 40 on the global coordinates based on the positional information on the global coordinates obtained from the QR code C, and the position and the angle of the QR code C on the camera coordinates. The running object control board 61 realizes, by utilizing the obtained position and angle F of the reference point R, driving and controlling of the running motors 45a and 45b by the driving control board 66 to run the running object 40 on an accurate running course according to running data received from the main control board.

The wireless LAN device 68 receives running data generated in the main control board 21 at a predetermined timing before execution of each race, and transmits the positions of the running object 40 on the global coordinates of the reference point R derived by the running object control board 61 in each race, or the positions and the angle F to the main control board 21.

A position detection process of the running object 40 based on QR codes C on the information arrangement surface, which is executed in each running object 40, will be described below.

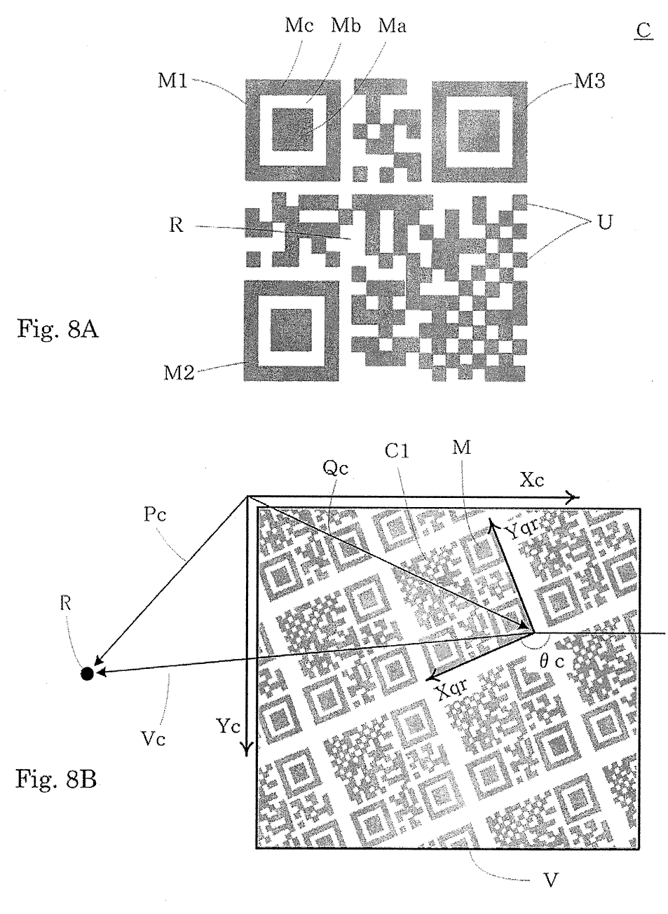

FIG. 8A is an explanatory view of an enlarged code pattern of a QR code C used in this embodiment.

The QR code C of the embodiment is a graphic pattern having a square area with about 7 mm sides in which modules U as information recording units having predetermined sizes (e.g., 0.333 mm angle) and identified by black and white binaries are arrayed in 21 by 21. Position detection markers M (M1 to M3) are disposed on its three corners, and an area other than the markers M is an encoding area R for recording positional information.

The marker M includes a black portion Ma of 3×3 modules in a center, a white portion Mb of 5×5 modules on its outside, and a black portion Mc of 7×7 modules on its further outside. When an image with a QR code C captured therein is scanned along a straight line passing through the center of a marker M, no matter how the QR code C is inclined in the image, a black, white, black, white and black pattern with a length ratio of 1:1:3:1:1 will be detected.

In this embodiment, by easily detecting markers M based on the above mentioned geometrical features of QR codes C, QR codes C are extracted from images to detect positions of the running object 40.

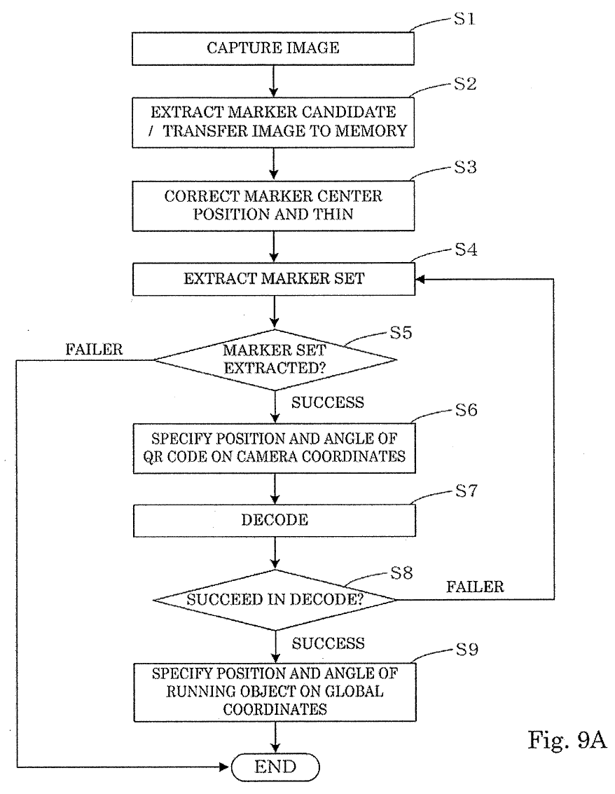

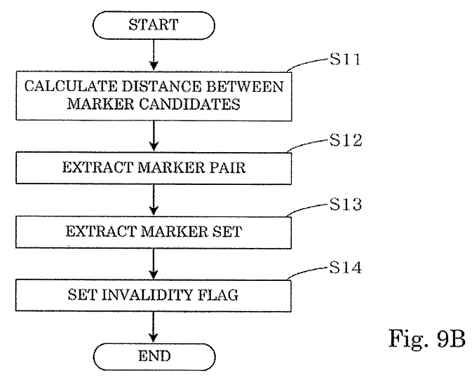

FIG. 9A is a flowchart illustrating a flow of a position detection process executed in each running object 40.

As illustrated in FIG. 9A, in this embodiment, the position detection process is started by capturing of the information arrangement surface by the camera device 46 (step S1). This process is repeatedly executed by, for example, 120 times per second under control of the capturing control board 62.

In step S2, noise is removed from the image captured in step S1 by a median filter (one of the noise removing methods in image process: noise is removed by sorting certain position (pixel) and surrounding pixels to take their medial value). Then, the image processing board 64 scans the captured image in a predetermined direction (e.g., Xc direction in camera coordinates). Thereafter, each time a black, white, black, white and black pattern with a length ratio of 1:1:3:1:1 is detected, the image processing board 64 picks up the pattern as a marker candidate. For each picked-up marker candidate, the center position thereof and one module length which is a value obtained by multiplying the length (number of pixels) of the pattern by 1/7 are recorded. In step S2 of the embodiment, to prevent an increase in processing loads when excessive erroneous recognition of marker candidates occur, marker candidates are picked up within a predetermined upper limit number (e.g., 64).

In step S2, the image processing board 64 derives a threshold value to binarize the captured image. Transfer of the captured image to the image memory 65 is simultaneously executed with the execution of step S2. The threshold value may be derived every time step S2 is executed. Alternatively, a threshold value derived in step S2 firstly executed after a start up of the device may be used as a fixed value, thereby omitting threshold deriving processes in each of step S2 thereafter.

In subsequent step S3, based on the fact that the black portion Ma of each marker M is a square area painted “BLACK”, correction and thinning processes of the center positions of the marker candidates picked up in step S2 are executed by the running object control board 61.

Specifically, for image data transferred to the image memory 65, pixels in upper-lower and left-right directions (+Xc, −Xc, +Yc, and −Yc directions in camera coordinates) of the center positions of the marker candidates picked up by the image processing board 64 are scanned to detect a boundary of switching from a “BLACK” pixel to a “WHITE” pixel, and the center positions of the marker candidates are corrected to the center points of detected upper-lower and left-right boundaries. When a distance between upper and lower boundaries is significantly different from that between left and right boundaries, the portion is not a black portion Ma. Accordingly, if a ratio of the both is outside a predetermined range, the marker candidates are deleted (thinned). Thus, the center positions are corrected, and predetermined ID numbers are added to the thinned marker candidates in order of closeness to the image center.

In subsequent step S4, based on the fact that the distances among three markers M belonging to a single QR code C are predetermined values (the distances between two adjacent markers (M1-M2, and M1-M3) are 14 modules, and the distance between diagonal markers (M2-M3) is √2 times thereof), three marker candidates (marker set) considered to belong to a single QR code C are extracted for each of the marker candidates extracted in step S3.

FIG. 9B illustrates step S4 in detail.

In this step, first, a distance (number of pixels) between the centers of the marker candidates extracted in step S3 is calculated, and the calculated distance between the centers is recorded in a two-dimensional array form in which IDs of the marker candidates are keys (step S11). Accordingly, inter-marker distances for all combinations of two marker candidates selected from the marker candidates extracted in step S3 are recorded. In this two-dimensional array, a flag indicating validity/invalidity of each inter-center distance is recorded together with each inter-center distance. By not executing S12 and S13 for inter-center distances for which invalidity flags have been recorded, processing loads can be reduced, and processing time can be shortened.

The invalidity flag can be recorded, in addition to the case of step S13 described below, when a difference from an inter-marker distance in a QR code C detected in a previously captured image is larger than a predetermined value, or when a difference of one module lengths recorded for two marker candidates whose inter-center distance has been calculated is larger than a predetermined value.

In subsequent step S12, based on the fact that an inter-center distance between two markers belonging to a single QR code C is equal to 14 modules, under a condition that the inter-center distance calculated in step S11 is roughly equal to 14 modules, more specifically, under a condition that a value obtained by dividing each inter-center distance by a one module length recorded for a marker candidate of lower ID number of the two marker candidates whose inter-center distance has been calculated is within a predetermined error range from “14”, the two marker candidates are extracted as a marker pair (first and second marker candidates).

In subsequent step S13, a marker candidate in which a ratio (L1/L) of a distance L1 from one marker candidate of the marker pair extracted in step S12 to a distance L indicating the inter-center distance of the marker pair is within a predetermined error range from “1”, and a radio (L2/L) of a distance L2 from the other marker candidate of the marker pair to the inter-center distance L is within a predetermined error range from “√2” is extracted as a third marker candidate constituting a marker set.

In step S13, it is also possible to extract the third marker candidate, for example, under a condition that a pixel density of “BLACK” in the surrounding area of the QR code C (quiet zone: empty portion around a two-dimensional code necessary for reading the two-dimensional code (also called margin)) specified by the extracted three marker candidates is equal to or smaller than a fixed value, in addition to the above mentioned condition.

In subsequent step S14, to prevent repetitive execution of steps S12 and S13 at the time the process is returned from below described step S8 to step S4, invalidity flags are recorded for inter-center distances between any of the three marker candidates constituting the marker set specified in steps S12 and S13 and all the other marker candidates.

Referring back to FIG. 9A, in step S5, whether the marker set has been successfully extracted in step S4 is determined. If the extraction has been unsuccessful, the process is finished, because it is considered that no further QR code C can be specified from the image.

On the other hand, if the marker set has been detected, the process proceeds to step S6 to specify a position and an angle of the QR code C on the camera coordinates based on the center position of each detected marker candidate. In step S7, the image processing board 64 decodes the QR code C to obtain positional information recorded in the QR code C. In step S7, to simplify the process, the QR code C is decoded based on pixel values of center positions of 21×21 modules U in the QR code C.

In step S8, whether the decoding of step S7 has been successful is determined. If unsuccessful, the process returns to step S4 to extract a marker set belonging to the other QR code C in the image captured in step S1.

On the other hand, if successful decoding is determined in step S8, the process proceeds to step S9 to carry out coordinate conversion described below based on the position and the angle of the QR code C on the camera coordinates specified in step S6 and the positional information obtained in step S7, thereby deriving a reference point R and an angle F of the running object.

FIG. 8B is an explanatory view of an exemplary image of the information arrangement surface captured by the camera device 46 in step S1.

Presuming that three marker candidates M of a QR code C1 shown in FIG. 8B are extracted as a marker set in step S4, QR coordinates (Xqr and Yqr) are derived from a positional relation among the three markers M. Thus, if camera coordinates are taken as shown as (Xc and Yc) of FIG. 8B, a vector Vc from the origin of the QR coordinates to the reference point R of the running object 40 can be represented by the following equation (3), using a position Qc of the origin of the QR coordinates on the camera coordinates, and the known position Pc of the reference point R of the running object 40 on the camera coordinates.

Vc=Pc−Qc (3)

Coordinate values (Pqx and Pqy) of the reference point R of the running object 40 in the QR coordinate system can be obtained by rotating the vector Vc by θc according to the following equation (4), in which θc is an angle of the QR code C1 on the camera coordinates.

Pqx=Vcx'cos θc−Vcy×sin θc

Pqy=Vcx×sin θc+Vcy×cos θc (4)

Thus, coordinate values (Pgx and Pgy) of the reference point R of the running object 40 in the global coordinate system can be obtained by the following equation (5), in which (Gx and Gy) are coordinate values obtained by decoding the QR code C1 in step S7, and an angle θg indicating an advancing direction of the running object in the global coordinate system can be obtained by the following equation (6).

Pgx=Pqx+Gx

Pgy=Pqy+Gy (5)

θg=−θc (6)

The exemplary embodiment of the present invention has been described. However, the embodiment is in no way limitative of the present invention, and various changes and modifications can be made within appended claims of the invention.

For example, the embodiment has been described by way of a case in which the present invention is applied to a horse-race game device in which a plurality of model objects having horse shapes race against one another to arrive earlier. However, the invention can be applied to a game device in which a game progresses as a plurality of model objects having optional shapes run on a first running surface in an optional manner, such as a soccer game device in which a plurality of model objects having soccer player shapes run on a field chasing a ball.

The embodiment has been described by way of a case in which the two-dimensional codes have been arrayed in a matrix along the XY axes of the orthogonal coordinates (global coordinates) fixed on the second running surface. However, as long as one or more two-dimensional codes are always included within the field angle of the capturing means disposed in the running object on the second running surface, the two-dimensional codes can be disposed in any regular or irregular arrangement.

Similarly, the embodiment has been described by way of a case in which the coordinate values of the reference point R of the running object are derived by the coordinate conversion using the orthogonal coordinates fixed on the second running surface or the captured image. However, kinds of coordinates to be used, calculation methods for deriving a reference point, selection of a reference point on the running object and so on are optional.

The embodiment has been described by way of a case in which the two-dimensional codes are arranged on the second running surface. However, the two-dimensional codes of the present invention can be arranged on an optional surface (information arrangement surface) extending in a direction parallel to the second running surface and capturable from the capturing means. For example, the bottom plate is made of a transparent plate member, and the two-dimensional codes are arranged on a surface set below the transparent bottom plate. In this way, the two-dimensional codes can be arranged in a place different from that of the embodiment of the game device.

The embodiment has been described by taking, as an example, the game device in which 12 satellites are arranged around the device main body. However, the game device of the present invention can include 13 or more, or 11 or less satellites.

The device configurations, the functional configurations, the specific methodology in each of the processes, the order of the processes and so on are only examples, and are in no way limitative of the present invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A game device, in which a game progresses as a plurality of model objects run, comprising:
a first running surface;
a second running surface positioned below the first running surface;
a plurality of running objects which run on a track of the second running surface, each of the plurality of running objects including capturing means for capturing an image; and
the plurality of model objects each of which runs on the first running surface following any of the running objects;
a plurality of two-dimensional codes for recording positional information in the second running surface, the plurality of two-dimensional codes being arranged in an information arrangement surface extending in parallel to the second running surface and capturable from the capturing means; and
a position detection means for detecting a position of the running object based on the positional information recorded in the two-dimensional code captured by the capturing means; wherein:
the plurality of two-dimensional codes are arranged with sizes and a sequence in which, irrespective of the position of any of the plurality of running objects on the track of the second running surface, at least one or more of the plurality of two-dimensional codes are included in a field angle of the capturing means thereof.

2. A game device according to claim 1, wherein the position detection means detects the position of the running object, based on a position and an angle of the two-dimensional code in the image captured by the capturing means and the positional information recorded in the two-dimensional code.

3. A game device according to claim 1 or 2, wherein each of the plurality of running objects includes:
the position detection means; and
driving control means for controlling running of the running object based on the position of the running object detected by the position detection means.

4. A game device according to any one of claims 1 to 3, wherein each of the plurality of running objects further includes lighting means for lighting the field angle of the capturing means.

5. A game device according to any one of claims 1 to 4, wherein:
the plurality of two-dimensional codes are arranged in the information arrangement surface with sizes and a sequence in which, irrespective of the positions of any of the plurality of running objects on the track of the second running surface, at least two of the plurality of two-dimensional codes are included in the field angle of the capturing means thereof; and
the position detection means executes, when position detection of any of the running objects based on one of the two-dimensional codes in the image captured by the capturing means fails, position detection of the running object based on another of the two-dimensional codes in the captured image.
